(19) United States
(12) Patent Application Publication
(10) Pub. No.: US 2018/0261142 A1
(43) Pub. Date: Sep. 13, 2018

(54) DISPLAY DEVICE AND CONTROL METHOD THEREFOR

(71) Applicant: SHARP KABUSHIKI KAISHA, Sakai-City,Osaka (JP)

(72) Inventors: Hongbing WENG, Sakai City (JP); Masaaki NISHIO, Sakai City (JP); Noriyuki TANAKA, Sakai City (JP)

(21) Appl. No.: 15/761,873

(22) PCT Filed: Oct. 28, 2016
(86) PCT No.: PCT/JP2016/082016

§ 371 Date: Mar. 21, 2018

(30) Foreign Application Priority Data
Nov. 4, 2015 (JP) 2015-216275

(51) Int. Cl. G09G 3/20; G09G 3/36; G06F 1/32

(52) U.S. Cl. CPC G09G 3/2003; G09G 3/36; G09G 3/2044; G09G 2320/0666; G09G 2330/023; G09G 2360/12; G06F 1/3287

(57) ABSTRACT

A frame memory 23 includes a first storage unit 231 for storing normal image data and a second storage unit 232 for storing reduced color image data. A reduced color image generation unit 122 generates the reduced color image data by performing a dithering process on the normal image data. A drive circuit of a liquid crystal panel 11 drives the liquid crystal panel 11 based on the normal image data stored in the first storage unit 231 in a normal mode, and drives the liquid crystal panel 11 based on the reduced color image data stored in the second storage unit 232 in a reduced color mode. In the reduced color mode, supplying a power supply voltage to the first storage unit 231 is stopped. When switching to the normal mode, supplying the power supply voltage to the first storage unit 231 is started, and the drive circuit drives the liquid crystal panel 11 based on the reduced color image data stored in the second storage unit 232 until the normal image data is written to the first storage unit 231.

### TECHNICAL FIELD

The present invention relates to a display device, and more particularly to a display device performing reduced color display and a control method therefor.

### BACKGROUND ART

In order to reduce power consumption, some display devices included in portable electronic devices or the like perform, in addition to normal color display (hereinafter referred to as normal display), reduced color display in which the number of display colors is reduced as compared with normal display. For example, a display device performing reduced color display performs full color display (2²⁴ color display) based on normal image data consisting of RGB data each having eight bits as normal display, and performs eight color display based on reduced color image data consisting of RGB data each having one bit as reduced color display.

The reduced color image data can be obtained, for example, by using upper bits of the normal image data as it is. However, this method has a problem that since information of lower bits of the normal image data is lost, a reduced color image is significantly different from a normal image. Thus, as a method for solving this problem, a method of performing a dithering process when obtaining the reduced color image data is known. Using this method, it is possible to display the reduced color image close to the normal image as compared with a case where the dithering process is not performed.

Related to the present invention, Patent Document 1 describes an integrated circuit device that reduces power consumption of a memory in a reduced color mode. The integrated circuit device reads image data from a plurality of memory blocks in a normal mode and reads the image data from a selected part of the memory blocks in the reduced color mode. The memory blocks selected in the reduced color mode are arranged closer to a circuit in a next stage than other memory blocks.

### PRIOR ART DOCUMENT

### Patent Document

[Patent Document 1] Japanese Laid-Open Patent Publication No. 2009-98354

### SUMMARY OF THE INVENTION

### Problems to be Solved by the Invention

In the display device that obtains the reduced color image data by the dithering process, a display screen is disturbed when switching from reduced color display to normal display. In order to hide the disturbance, conventional display devices performing reduced color display perform black display when switching from reduced color display to normal display. However, a user feels unnatural that the display screen becomes black for a moment. Furthermore, the conventional display devices performing reduced color display supply a power supply voltage to an entire frame memory even when performing reduced color display. Therefore, power consumption becomes larger than necessary.

Therefore, one object of the present invention is to provide a display device capable of preventing a disturbance of a display screen when switching between normal display and reduced color display. Furthermore, another object of the present invention is to provide a low power consumption display device which can prevent such a disturbance of the display screen.

### Means for Solving the Problems

According to a first aspect of the present invention, there is provided a display device performing reduced color display, including: a display panel; a drive circuit configured to drive the display panel; a frame memory including a first storage unit configured to store normal image data for normal display and a second storage unit configured to store reduced color image data for reduced color display separately from the first storage unit; and a display control circuit including a reduced color image generation unit configured to generate the reduced color image data based on the normal image data, the display control circuit configured to control the drive circuit and the frame memory, wherein the drive circuit is configured to drive the display panel based on the normal image data stored in the first storage unit in a normal mode and drive the display panel based on the reduced color image data stored in the second storage unit in a reduced color mode.

According to a second aspect of the present invention, in the first aspect of the present invention, the display control circuit is configured to stop supplying a power supply voltage to the first storage unit in the reduced color mode.

According to a third aspect of the present invention, in the second aspect of the present invention, when switching from the reduced color mode to the normal mode, the display control circuit is configured to start supplying the power supply voltage to the first storage unit and write the normal image data to the first storage unit, and the drive circuit is configured to drive the display panel based on the reduced color image data stored in the second storage unit until the normal image data is written to the first storage unit.

According to a fourth aspect of the present invention, in the second aspect of the present invention, the display control circuit is configured to stop supplying the power supply voltage to the second storage unit in the normal mode.

According to a fifth aspect of the present invention, in the fourth aspect of the present invention, when switching from the normal mode to the reduced color mode, the display control circuit is configured to start supplying the power supply voltage to the second storage unit and write the reduced color image data to the second storage unit, and the drive circuit is configured to drive the display panel based on the normal image data stored in the first storage unit until the reduced color image data is written to the second storage unit.

According to a sixth aspect of the present invention, in any of the first to fifth aspects of the present invention, the reduced color image generation unit is configured to generate the reduced color image data by performing a dithering process on the normal image data.

According to a seventh aspect of the present invention, in the first aspect of the present invention, the display panel is a liquid crystal panel.

According to an eighth aspect of the present invention, there is provided a control method for a display device having a display panel and a frame memory and performing reduced color display, the method including steps of: driving the display panel; storing normal image data for normal display in a first storage unit in the frame memory; generating reduced color image data for reduced color display based on the normal image data; and storing the reduced color image data in a second storage unit in the frame memory separately from the first storage unit, wherein in driving, the display panel is driven based on the normal image data stored in the first storage unit in a normal mode and is driven based on the reduced color image data stored in the second storage unit in a reduced color mode.

### Effects of the Invention

According to the first or eighth aspect of the present invention, it is possible to switch between normal display and reduced color display without interruption, by providing a storage area for the normal image data and a storage area for the reduced color image data in the frame memory.

According to the second aspect of the present invention, it is possible to reduce power consumption of the display device without affecting display, by stopping supplying the power supply voltage to the first storage unit not used in the reduced color mode.

According to the third aspect of the present invention, it is possible to prevent a disturbance of a display screen, by continuing reduced color display until a preparation for normal display is completed when switching from reduced color display to normal display.

According to the fourth aspect of the present invention, it is possible to further reduce the power consumption of the display device without affecting display, by stopping supplying the power supply voltage to the second storage unit not used in the normal mode.

According to the fifth aspect of the present invention, it is possible to prevent the disturbance of the display screen, by continuing normal display until a preparation for reduced color display is completed when switching from normal display to reduced color display.

According to the sixth aspect of the present invention, it is possible to display a reduced color image close to a normal image by performing the dithering process when generating the reduced color image data.

According to the seventh aspect of the present invention, in the liquid crystal display device, it is possible to switch between normal display and reduced color display without interruption, by providing the storage area for the normal image data and the storage area for the reduced color image data in the frame memory.

### BRIEF DESCRIPTION OF THE DRAWINGS

FIG. 1 is a block diagram showing a configuration of a liquid crystal display device according to a first embodiment of the present invention.

FIG. 2 is a diagram showing a configuration example of a frame memory of the liquid crystal display device shown in FIG. 1.

FIG. 3 is a flowchart showing an operation of the liquid crystal display device shown in FIG. 1.

FIG. 4 is a block diagram showing a configuration of a liquid crystal display device according to a second embodiment of the present invention.

FIG. 5 is a diagram showing a detailed configuration of a frame memory of the liquid crystal display device shown in FIG. 4.

FIG. 6 is a flowchart showing an operation of the liquid crystal display device shown in FIG. 4.

### MODES FOR CARRYING OUT THE INVENTION

### First Embodiment

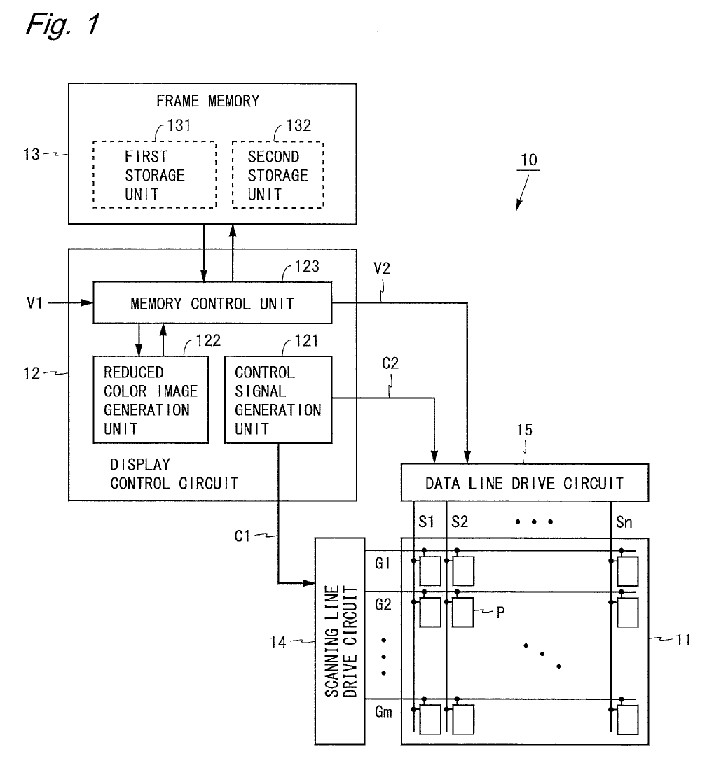

FIG. 1 is a block diagram showing a configuration of a liquid crystal display device according to a first embodiment of the present invention. A liquid crystal display device 10 shown in FIG. 1 includes a liquid crystal panel 11, a display control circuit 12, a frame memory 13, a scanning line drive circuit 14, and a data line drive circuit 15. The liquid crystal display device 10 switches an operation mode between a normal mode and a reduced color mode. The liquid crystal display device 10 performs normal display (normal color display) in the normal mode and performs reduced color display (display in which the number of display colors is reduced as compared with normal display) in the reduced color mode. Hereinafter, it is assumed that m and n are integers not less than 2.

The liquid crystal panel 11 includes m scanning lines G1 to Gm, n data lines S1 to Sn, and (m×n) pixel circuits P. The scanning lines G1 to Gm are arranged in parallel with each other. The data lines S1 to Sn are arranged in parallel with each other so as to intersect with the scanning lines G1 to Gm perpendicularly. The scanning lines G1 to Gm and the data lines S1 to Sn intersect at (m×n) positions. The (m×n) pixel circuits P are provided corresponding to (m×n) intersections.

The display control circuit 12 is a control circuit of the liquid crystal display device 10. A video signal V1 supplied from an outside of the liquid crystal display device 10 is input to the display control circuit 12. The display control circuit 12 outputs a control signal C1 to the scanning line drive circuit 14, and outputs a control signal C2 and a video signal V2 to the data line drive circuit 15. The control signal C1 includes a gate start pulse, a gate clock, and the like. The control signal C2 includes a source start pulse, a source clock, and the like.

The scanning line drive circuit 14 and the data line drive circuit 15 function as a drive circuit of the liquid crystal panel 11. More specifically, the scanning line drive circuit 14 sequentially selects one scanning line from among the scanning lines G1 to Gm based on the control signal C1, and applies a write voltage (voltage with which a write control transistor (not shown) in the pixel circuit P becomes an ON state) to the selected scanning signal line. With this, n pixel circuits P connected to the selected scanning line are selected. The data line drive circuit 15 applies n voltages in accordance with the video signal V2, to the data lines S1 to Sn based on the control signal C2. With this, the n voltages are written to the n selected pixel circuits P, respectively.

The display control circuit 12 includes a control signal generation unit 121, a reduced color image generation unit 122, and a memory control unit 123. The control signal generation unit 121 generates the control signal C1 for the scanning line drive circuit 14 and the control signal C2 for the data line drive circuit 15. The memory control unit 123 controls writing to and reading from the frame memory 13. The frame memory 13 includes a first storage unit 131 and a second storage unit 132.

The video signal V1 input to the display control circuit 12 includes image data for normal display (hereinafter referred to as normal image data). The normal image data included in the video signal V1 is stored in the first storage unit 131 of the frame memory 13. The reduced color image generation unit 122 generates image data for reduced color display (hereinafter referred to as reduced color image data) based on the normal image data stored in the first storage unit 131 (or the normal image data included in the video signal V1). The reduced color image data is image data corresponding to a smaller number of display colors than the normal image data. The reduced color image generation unit 122 performs a dithering process on the normal image data when generating the reduced color image data based on the normal image data. The reduced color image data generated by the reduced color image generating unit 122 is stored in the second storage unit 132 of the frame memory 13.

In this manner, the frame memory 13 includes the first storage unit 131 for storing the normal image data for normal display and the second storage unit 132 for storing the reduced color image data for reduced color display separately from the first storage unit 131. The display control circuit 12 includes the reduced color image generation unit 122 for generating the reduced color image data based on the normal image data, and controls the drive circuit (scanning line drive circuit 14 and data line drive circuit 15) of the liquid crystal panel 11 and the frame memory 13.

The liquid crystal display device 10 performs normal display based on the normal image data in the normal mode and performs reduced color display based on the reduced color image data in the reduced color mode. More specifically, in the normal mode, the display control circuit 12 outputs the video signal V2 including the normal image data stored in the first storage unit 131. The data line drive circuit 15 drives the data lines S1 to Sn based on the normal image data included in the video signal V2. In the reduced color mode, the display control circuit 12 outputs the video signal V2 including the reduced color image data stored in the second storage unit 132. The data line drive circuit 15 drives the data lines S1 to Sn based on the reduced color image data included in the video signal V2.

Note that in the liquid crystal display device 10, the display control circuit 12 may include the frame memory 13, or all or part of the display control circuit 12, the frame memory 13, the scanning line drive circuit 14, and the data line drive circuit 15 may be formed on the liquid crystal panel 11 monolithically.

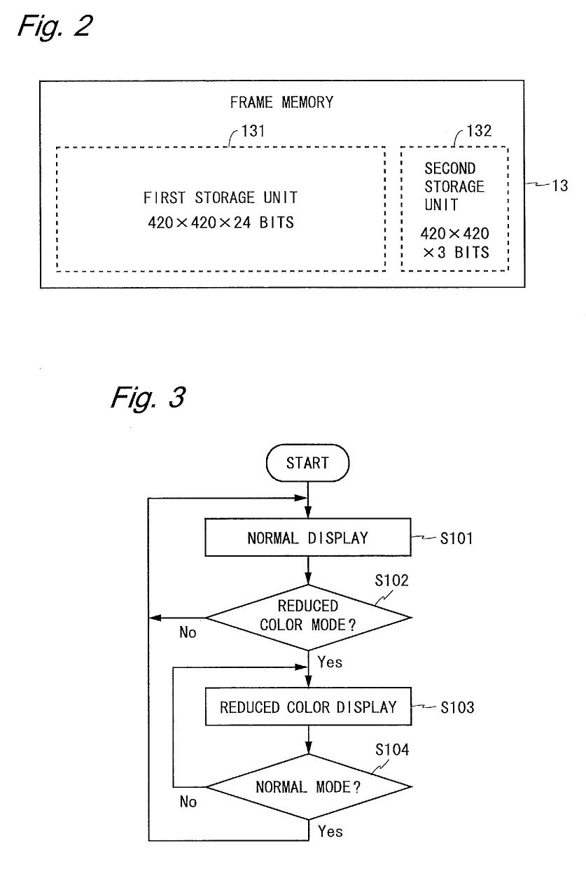

FIG. 2 is a diagram showing a configuration example of the frame memory 13. In the example shown in FIG. 2, it is assumed that sizes of the normal image and the reduced color image are 420×420 pixels, the normal image data consists of RGB data each having eight bits, and the reduced color image data consists of RGB data each having one bit. In this case, a size of the first storage unit 131 is 420×420×24=4,233,600 bits or more, and a size of the second storage unit 132 is 420×420×3=529,200 bits or more. A size of the frame memory 13 is 4,762,800 bits or more, which is a sum of both. The liquid crystal display device 10 performs full color display (2²⁴ color display) based on the normal image data in the normal mode, and performs eight color display based on the reduced color image data in the reduced color mode.

FIG. 3 is a flowchart showing an operation of the liquid crystal display device 10. As shown in FIG. 3, at first, the liquid crystal display device 10 performs normal display (step S101). In step S101, the display control circuit 12 outputs the video signal V2 including the normal image data stored in the first storage unit 131 of the frame memory 13. The data line drive circuit 15 drives the data lines S1 to Sn based on the normal image data included in the video signal V2. In this manner, in the normal mode, the drive circuit of the liquid crystal panel 11 drives the liquid crystal panel 11 based on the normal image data stored in the first storage unit 131.

Next, the liquid crystal display device 10 determines whether the operation mode is the reduced color mode (step S102). The liquid crystal display device 10 goes to step S101 when No is determined in step S102, and goes to step S103 when Yes is determined in step S102.

In the latter case, the liquid crystal display device 10 performs reduced color display (step S103). In step S103, the display control circuit 12 outputs the video signal V2 including the reduced color image data stored in the second storage unit 132 of the frame memory 13. The data line drive circuit 15 drives the data lines S1 to Sn based on the reduced color image data included in the video signal V2. In this manner, in the reduced color mode, the drive circuit of the liquid crystal panel 11 drives the liquid crystal panel 11 based on the reduced color image data stored in the second storage unit 132.

Next, the liquid crystal display device 10 determines whether the operation mode is the normal mode (step S104). The liquid crystal display device 10 goes to step S103 when No is determined in step S104, and goes to step S101 when Yes is determined in step S104.

As described above, the liquid crystal display device 10 according to the present embodiment includes a display panel (liquid crystal panel 11), the drive circuit (scanning line drive circuit 14 and data line drive circuit 15) for driving the display panel, the frame memory 13 including the first storage unit 131 for storing the normal image data for normal display and the second storage unit 132 for storing the reduced color image data for reduced color display separately from the first storage unit, and the display control circuit 12 including the reduced color image generation unit 122 for generating the reduced color image data based on the normal image data, the display control circuit 12 for controlling the drive circuit and the frame memory 13. In the normal mode, the drive circuit of the display panel drives the display panel based on the normal image data stored in the first storage unit 131. In the reduced color mode, the drive circuit of the display panel drives the display panel based on the reduced color image data stored in the second storage unit 132. Therefore, according to the liquid crystal display device 10 according to the present embodiment, it is possible to switch between normal display and reduced color display without interruption, by storing both of the normal image data and the reduced color image data in the frame memory 13.

Furthermore, the reduced color image generating unit 122 generates the reduced color image data by performing the dithering process on the normal image data. Therefore, it is possible to display the reduced color image close to the normal image.

Note that in the above description, the reduced color image generation unit 122 generates the reduced color image data by performing the dithering process on the normal image data. Alternatively, the reduced color image generating unit 122 may generate the reduced color image data by performing process other than the dithering process on the normal image data.

### Second Embodiment

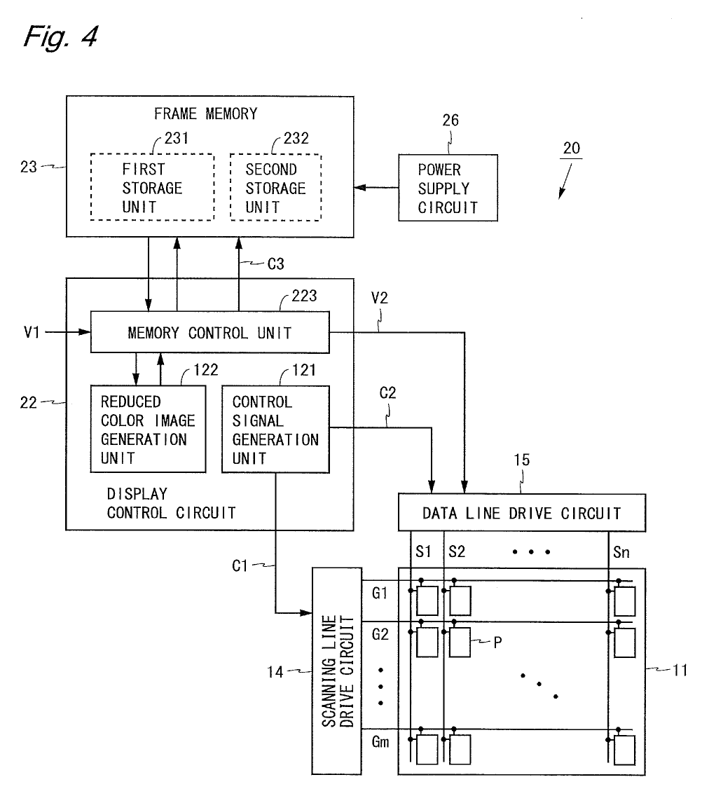

FIG. 4 is a block diagram showing a configuration of a liquid crystal display device according to a second embodiment of the present invention. A liquid crystal display device 20 shown in FIG. 4 is obtained by replacing the display control circuit 12 and the frame memory 13 in the liquid crystal display device 10 according to the first embodiment, with a display control circuit 22 and a frame memory 23. The display control circuit 22 is obtained by replacing the memory control unit 123 in the display control circuit 12, with a memory control unit 223. In addition, a power supply circuit 26 omitted in FIG. 1 is described in FIG. 4. Among constituent elements of the present embodiment, same elements as those of the first embodiment are provided with the same reference numerals, and description thereof will be omitted. Hereinafter, it is assumed that p and q are integers not less than 2.

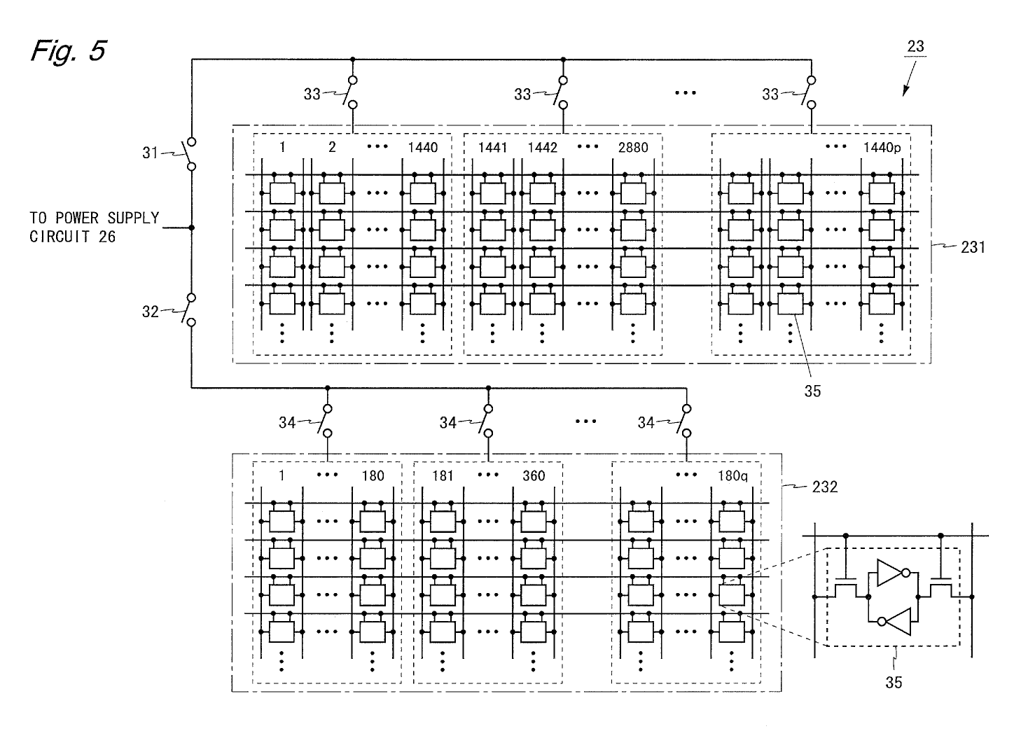

FIG. 5 is a diagram showing a detailed configuration of the frame memory 23. As with the frame memory 13, the frame memory 23 includes a first storage unit 231 for storing the normal image data and a second storage unit 232 for storing the reduced color image data separately from the first storage unit 231. The first storage unit 231 and the second storage unit 232 include a plurality of memory cells 35 arranged two-dimensionally. One word of the first storage unit 231 is (1440×p) bits, and the first storage unit 231 stores the normal image data corresponding to (60×p) pixels aligned in a horizontal direction, per one word. One word of the second storage unit 232 is (180×q) bits, and the second storage unit 232 stores the reduced color image data corresponding to (60×q) pixels aligned in the horizontal direction, per one word. Note that p and q may have a same value.

The frame memory 23 includes switches 31, 32, p switches 33, and q switches 34. The first storage unit 231 is divided into p blocks, and the p switches 33 are provided corresponding to the p blocks. The second storage unit 232 is divided into q blocks, and the q switches 34 are provided corresponding to the q blocks. One end (lower end in FIG. 5) of the switch 33 is connected to a power supply line (not shown) in the block of the first storage unit 231, and the other end of the switch 33 is connected to one end of the switch 31. One end (lower end in FIG. 5) of the switch 34 is connected to a power supply line (not shown) in the block of the second storage unit 232, and the other end of the switch 34 is connected to one end of the switch 32. The power supply line in the block is connected to power supply terminals of inverter circuits included in the memory cell 35 in the block. The other ends of the switches 31, 32 are connected to the power supply circuit 26 provided outside the frame memory 23.

As shown in FIG. 4, the memory control unit 223 outputs a control signal C3 to the frame memory 23. The control signal C3 includes control signals of the switches 31 to 34. Out of the p switches 33, the memory control unit 223 controls switches of which number corresponds to a horizontal size of the normal image, to the ON state. For example, when the size in the horizontal direction of the normal image is 420 pixels, the memory control unit 223 controls first to seventh switches to the ON state among the p switches 33. Among the q switches 34, the memory control unit 223 controls switches of which number corresponds to a size in the horizontal direction of the reduced color image, to the ON state. For example, when the size in the horizontal direction of the reduced color image is 360 pixels, the memory control unit 223 controls first to sixth switches to the ON state among the q switches 34.

Furthermore, the memory control unit 223 controls the switch 31 to the ON state and controls the switch 32 to an OFF state in the normal mode. The memory control unit 223 controls the switch 31 to the OFF state and controls the switch 32 to the ON state in the reduced color mode. Therefore, in the normal mode, a power supply voltage is supplied only to the blocks of which number corresponds to the size in the horizontal direction of the normal image in the first storage unit 231. In the reduced color mode, the power supply voltage is supplied only to the blocks of which number corresponds to the size in the horizontal direction of the reduced color image in the second storage unit 232. In this manner, the power supply voltage is supplied only to the blocks necessary for display in the frame memory 23 in the normal mode and the reduced color mode.

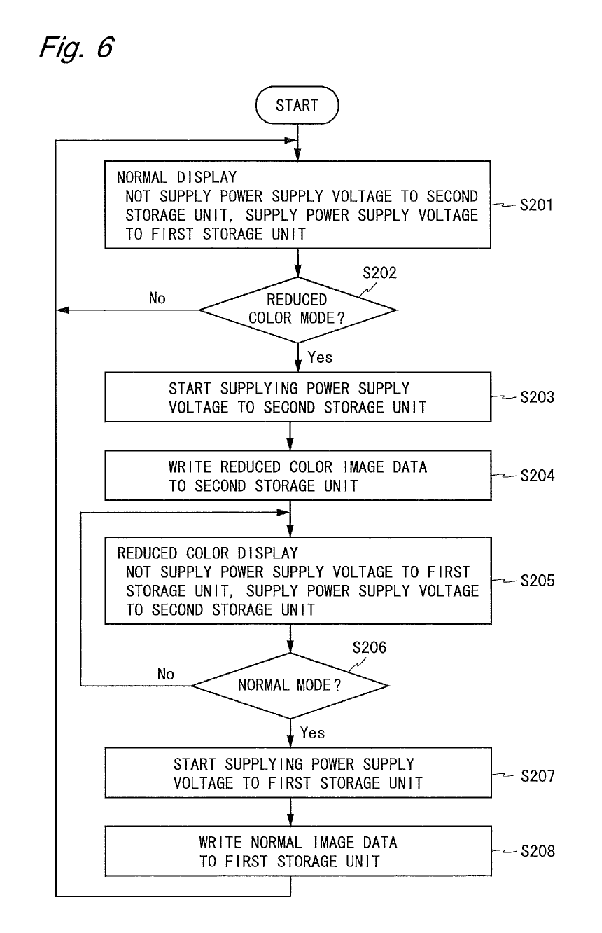

FIG. 6 is a flowchart showing an operation of the liquid crystal display device 20. As shown in FIG. 6, at first, the liquid crystal display device 20 performs normal display (step S201). In step S201, the display control circuit 22 and the data line drive circuit 15 operate in the same manner as in step S101 according to the first embodiment. At this time, the memory control unit 223 controls the switch 31 to the ON state and controls the switch 32 to the OFF state. Therefore, although the power supply voltage is supplied to the first storage unit 231 (more accurately, to the blocks of which number corresponds to the size in the horizontal direction of the normal image in the first storage unit 231), the power supply voltage is not supplied to the second storage unit 232.

Next, the liquid crystal display device 20 determines whether the operation mode is the reduced color mode (step S202). The liquid crystal display device 20 goes to step S201 when No is determined in step S202, and goes to step S203 when Yes is determined in step S202.

In the latter case, the memory control unit 223 controls the switch 32 to the ON state and starts supplying the power supply voltage to the second storage unit 232 (step S203). Next, the reduced color image generation unit 122 generates the reduced color image data based on the image data stored in the first storage unit 231, and the memory control unit 223 writes the generated reduced color image data to the second storage unit 232 (step S204). However, in steps S203 and S204, the liquid crystal display device 20 continues normal display. After executing step S204, the liquid crystal display device 20 goes to step S205.

Next, the liquid crystal display device 20 performs reduced color display (step S205). In step S205, the display control circuit 22 and the data line drive circuit 15 operate in the same manner as in step S103 according to the first embodiment. At this time, the memory control unit 223 controls the switch 31 to the OFF state and the switch 32 to the ON state. Therefore, the power supply voltage is supplied to the second storage unit 232 (more accurately, to the blocks of which number corresponds to the size in the horizontal direction of the reduced color image in the second storage unit 232), but the power supply voltage is not supplied to the first storage unit 231.

Next, the liquid crystal display device 20 determines whether the operation mode is the normal mode (step S206). The liquid crystal display device 20 goes to step S205 when determined No in step S206, and goes to step S207 when Yes is determined in step S206.

In the latter case, the memory control unit 223 controls the switch 31 to the ON state and starts supplying the power supply voltage to the first storage unit 231 (step S207). Next, the memory control unit 223 writes the normal image data to the first storage unit 231 (step S208). However, in steps S207 and S208, the liquid crystal display device 20 continues reduced color display. After executing step S208, the liquid crystal display device 20 goes to step S201.

As described above, in the liquid crystal display device 20 according to the present embodiment, the display control circuit 22 stops supplying the power supply voltage to the first storage unit 231 in the reduced color mode. By stopping supplying the power supply voltage to the first storage unit 231 not used in the reduced color mode in this manner, it is possible to reduce power consumption of the liquid crystal display device 20 without affecting display.

Furthermore, when switching from the reduced color mode to the normal mode, the display control circuit 22 starts supplying the power supply voltage to the first storage unit 231 and writes the normal image data to the first storage unit 231, and the drive circuit (scanning line drive circuit 14 and data line drive circuit 15) drives the display panel (liquid crystal panel 11) based on the reduced color image data stored in the second storage unit 232 until the normal image data is written to the first storage unit 231. As described above, when switching from reduced color display to normal display, it is possible prevent a disturbance of the display screen by continuing reduced color display until a preparation for normal display is completed.

Furthermore, the display control circuit 22 stops supplying the power supply voltage to the second storage unit 232 in the normal mode. By stopping supplying the power supply voltage to the second storage unit 232 not used in the normal mode in this manner, it is possible to further reduce the power consumption of the liquid crystal display device 20 without affecting display.

Furthermore, when switching from the normal mode to the reduced color mode, the display control circuit 22 starts supplying the power supply voltage to the second storage unit 232 and writes the reduced color image data to the second storage unit 232, and the drive circuit drives the display panel based on the normal image data stored in the first storage unit 231 until the reduced color image data is written to the second storage unit 232. As described above, when switching from normal display to reduced color display, the disturbance of the display screen can be prevented, by continuing normal display until a preparation for reduced color display is completed.

Note that in the above description, the memory control unit 223 controls the switch 32 to the OFF state in step S201, and controls the switch 32 to the ON state in step S202. Alternatively, the memory control unit 223 may control the switch 32 to the ON state fixedly. The display control circuit 22 may always supply the power supply voltage to the second storage unit 232 in this manner.

As for the liquid crystal display device according to the embodiments of the present invention, following modifications can be constituted. The liquid crystal display devices 10, 20 according to the first and second embodiments perform eight color display in the reduced color mode. Alternatively, the liquid crystal display device according to a modification may perform reduced color display other than eight color display in the reduced color mode. In particular, the liquid crystal display device according to a modification may perform monochrome display in the reduced color mode. Furthermore, the liquid crystal display device according to a modification may write compressed image data to the frame memory. For example, a liquid crystal display device according to a modification may write the normal image data compressed to ½ times to the frame memory, decompress the compressed normal image data read from the frame memory by a factor of 2, and display an image based on the decompressed normal image data. In this case, a size of the frame memory is halved as compared with a case of not compressing and decompressing the image data. Furthermore, the present invention can be applied to display devices other than liquid crystal display devices.

The present application is an application claiming priority based on Japanese Patent Application No. 2015-216275 filed on Nov. 4, 2015 entitled “Display device and control method therefor”, and the content of the application is incorporated herein by reference.

### INDUSTRIAL APPLICABILITY

Since the display device of the present invention has a feature that a disturbance of a display screen can be prevented when switching between normal display and reduced color display, the display device can be used for various kinds of display devices performing reduced color display, such as a liquid crystal display device.

### DESCRIPTION OF REFERENCE CHARACTERS

10, 20: LIQUID CRYSTAL DISPLAY DEVICE
11: LIQUID CRYSTAL PANEL
12, 22: DISPLAY CONTROL CIRCUIT
13, 23: FRAME MEMORY
14: SCANNING LINE DRIVE CIRCUIT
15: DATA LINE DRIVE CIRCUIT
26: POWER SUPPLY CIRCUIT
121: CONTROL SIGNAL GENERATION UNIT
122: REDUCED COLOR IMAGE GENERATION UNIT
123, 223: MEMORY CONTROL UNIT
131, 231: FIRST STORAGE UNIT
132, 232: SECOND STORAGE UNIT

1. A display device performing reduced color display, comprising:
a display panel;
a drive circuit configured to drive the display panel;
a frame memory including a first storage unit configured to store normal image data for normal display and a second storage unit configured to store reduced color image data for reduced color display separately from the first storage unit; and
a display control circuit including a reduced color image generation unit configured to generate the reduced color image data based on the normal image data, the display control circuit configured to control the drive circuit and the frame memory, wherein
the drive circuit is configured to drive the display panel based on the normal image data stored in the first storage unit in a normal mode and drive the display panel based on the reduced color image data stored in the second storage unit in a reduced color mode.

2. The display device according to claim 1, wherein the display control circuit is configured to stop supplying a power supply voltage to the first storage unit in the reduced color mode.

3. The display device according to claim 2, wherein when switching from the reduced color mode to the normal mode, the display control circuit is configured to start supplying the power supply voltage to the first storage unit and write the normal image data to the first storage unit, and the drive circuit is configured to drive the display panel based on the reduced color image data stored in the second storage unit until the normal image data is written to the first storage unit.

4. The display device according to claim 2, wherein the display control circuit is configured to stop supplying the power supply voltage to the second storage unit in the normal mode.

5. The display device according to claim 4, wherein when switching from the normal mode to the reduced color mode, the display control circuit is configured to start supplying the power supply voltage to the second storage unit and write the reduced color image data to the second storage unit, and the drive circuit is configured to drive the display panel based on the normal image data stored in the first storage unit until the reduced color image data is written to the second storage unit.

6. The display device according to claim 1, wherein the reduced color image generation unit is configured to generate the reduced color image data by performing a dithering process on the normal image data.

7. The display device according to claim 1, wherein the display panel is a liquid crystal panel.

8. A control method for a display device having a display panel and a frame memory and performing reduced color display, the method comprising steps of:
driving the display panel;
storing normal image data for normal display in a first storage unit in the frame memory;
generating reduced color image data for reduced color display based on the normal image data; and
storing the reduced color image data in a second storage unit in the frame memory separately from the first storage unit, wherein
in driving, the display panel is driven based on the normal image data stored in the first storage unit in a normal mode and is driven based on the reduced color image data stored in the second storage unit in a reduced color mode.

9. The display device according to claim 2, wherein the reduced color image generation unit is configured to generate the reduced color image data by performing a dithering process on the normal image data.

10. The display device according to claim 3, wherein the reduced color image generation unit is configured to generate the reduced color image data by performing a dithering process on the normal image data.

11. The display device according to claim 4, wherein the reduced color image generation unit is configured to generate the reduced color image data by performing a dithering process on the normal image data.

12. The display device according to claim 5, wherein the reduced color image generation unit is configured to generate the reduced color image data by performing a dithering process on the normal image data.
